(19) United States
(12) Patent Application Publication
(10) Pub. No.: US 2022/0237335 A1
(43) Pub. Date: Jul. 28, 2022

(54) EQUIPMENT STATE ANALYSIS DEVICE, EQUIPMENT STATE ANALYSIS METHOD, AND PROGRAM

(71) Applicant: NIPPON TELEGRAPH AND TELEPHONE CORPORATION, Tokyo (JP)

(72) Inventors: Masaki WAKI, Musashino-shi, Tokyo (JP); Kazuya ANDO, Musashino-shi, Tokyo (JP); Gen KOBAYASHI, Musashino-shi, Tokyo (JP); Ryoichi KANEKO, Musashino-shi, Tokyo (JP); Hiroaki TANIOKA, Musashino-shi, Tokyo (JP)

(73) Assignee: NIPPON TELEGRAPH AND TELEPHONE CORPORATION, Tokyo (JP)

(21) Appl. No.: 17/615,276

(22) PCT Filed: Jun. 3, 2019
(86) PCT No.: PCT/JP2019/022049

§ 371 Date: Nov. 30, 2021

(51) Int. Cl. G06F 30/13; G06F 30/23; G06F 30/17

(52) U.S. Cl. CPC G06F 30/13; G06F 2119/14; G06F 30/17; G06F 30/23

(57) ABSTRACT

An object of the present invention is to provide a facility state analysis apparatus, a facility state analysis method, and a program capable of extracting a pole having a high risk without an inspector visiting a site. The facility state analysis apparatus according to the present invention creates a pole model from a material characteristic, dimensions, and a structure model of a pole, highly accurately estimates, by using a finite element method, a facility state such as deflection and an inclination when tension by a separately created cable model is applied to the pole model, and visualizes strength remaining in a facility system.

### TECHNICAL FIELD

The present disclosure relates to a facility state analysis apparatus, a facility state analysis method, and a program for analyzing a state of a facility present outside by a finite element method.

### BACKGROUND ART

For poles such as utility poles and signal posts serving as an outdoor facility, an acceptable design load has been conventionally set for each pole. A designer estimates a maximum value of a load on a cable and another accessory planned to be laid, and selects a pole having a design load commensurate with the estimated load. Particularly, a branch line is laid on both ends and the like of a laid pole group, and a load applied to the pole group is balanced. Whether laying can be achieved is estimated in such a load design by applying, to conventional design data, a load to be newly added when a pole is newly set up and also when a cable and the like are added.

### CITATION LIST

### Patent Literature

PTL 1: JP 2018-195240 A

### SUMMARY OF THE INVENTION

### Technical Problem

In the related art, when a facility such as a pole and a cable is newly laid, a design is performed in the concept of used design tension based on a maximum value of a load that may occur on the facility. As an example, a pole with a design load that is calculated from a load on a cable to be used, a wind speed load in view of a maximum wind speed when a laying place is a residential area, a mountainous region, and the like, and the like, and that can withstand the maximum load is used.

However, in a facility group of poles, cables, and the like laid by the technique, how much tension is generated with no wind and the like, which is so-called effective tension, is not determined. Further, since a temperature of a sea water surface is high in Japanese waters due to warming in recent years, there is an increase in cases where a wind speed exceeding a maximum wind speed that is assumed in the past is generated due to a typhoon and the like coming ashore while maintaining force. A great deal of cost is required to recalculate all laid facilities and reconstruct poles to poles uniformly having a high design load in order to deal with the cases above.

In addition, as illustrated in FIG. 1, even in a case where a branch line needs to be installed on both ends of a pole group in view of used design tension, an unbalanced load is generated on a pole due to tension and the like in the facility group when the pole cannot be installed due to a private land or an obstacle at the time of actual construction, for example. When such a situation is left as is for a long period of time, the pole needs to be renewed in a period shorter than a design life, and thus an extra cost is required. In order to prevent this case, a pole having a great design load and capable of withstanding an unbalanced load of a facility system alone, which is referred to as a self-supporting strut without a need of a branch line, has been used. However, there is a problem in that a cost is higher and a cost for laying is also higher than a normal pole.

Further, as in PTL 1, the related-art technique has a function of creating a 3D model from three-dimensional point group data and measuring deflection and an inclination occurring in an actual pole, but there is no technique for calculating an unbalanced load, tension, and the like that are causes of the occurrence of the deflection and the inclination. In other words, there is a problem in that there is no technique for calculating how much load and wind speed a pole can withstand, which is so-called residual strength of a facility system, in consideration of an unbalanced load, a wind speed, and the like in the entire facility system, and it is difficult to reduce a cost in the entire facility system.

Thus, in order to solve the problems described above, an object of the present invention is to provide a facility state analysis apparatus, a facility state analysis method, and a program capable of extracting a pole having a high risk without an inspector visiting a site.

### Means for Solving the Problem

In order to achieve the object described above, the facility state analysis apparatus according to the present invention creates a pole model from a material characteristic, dimensions, and a structure model of a pole, highly accurately estimates, by using a finite element method, a facility state such as deflection and an inclination when tension by a separately created cable model is applied to the pole model, and visualizes strength remaining in a facility system.

Specifically, the facility state analysis apparatus according to the present invention includes a model creation unit configured to discretize a portion of a pole that is not in a ground, the pole having a truncated cone shape whose part is in the ground to represent the pole by elements, and represent a portion in the ground of the pole by ground elements of a horizontal spring in a direction horizontal to the ground and a vertical spring vertical to the ground, and a calculation unit configured to provide, to the elements and the ground elements, a fluctuation due to a disturbance in force applied to the pole and tension applied from a cable laid on the pole, and analyze a state change of the pole by a finite element method.

Furthermore, the facility state analysis method according to the present invention includes discretizing a portion of a pole that is not in a ground, the pole having a truncated cone shape whose part is in the ground to represent the pole by elements, and representing a portion in the ground of the pole by ground elements of a horizontal spring in a direction horizontal to the ground and a vertical spring vertical to the ground, and providing, to the elements and the ground elements, a fluctuation due to a disturbance in force applied to the pole and tension applied from a cable laid on the pole, and analyzing a state change of the pole by a finite element method.

The facility state analysis apparatus and method model a pole and a cable, estimate effective tension applied to the pole, and estimate how the pole becomes deformed by the effective tension by the finite element method. For example, for a pole having a unique material characteristic (such as a stress-strain curve in concrete or metal), the facility state analysis apparatus and method calculate the deformation of the entire pole in a simulation using the finite element method when any load is applied to a specific place of the pole. Furthermore, the facility state analysis apparatus and method can estimate how much of a residual force is present, which is so-called residual strength, as compared to a load (design load) that a pole group can withstand, based on a load and the amount of deformation estimated in a plurality of poles and cables.

Thus, the facility state analysis apparatus and method can extract a pole group having a high risk (great unbalanced load and small residual strength) without an inspector with a high level of skill inspecting all of the poles. Therefore, the present invention can provide the facility state analysis apparatus and the facility state analysis method capable of extracting a pole having a high risk without an inspector visiting a site.

When the disturbance is wind, the calculation unit of the facility state analysis apparatus according to the present invention represents a space by three axes, calculates the tension from a wind direction and a wind speed for each component, and combines the tension of each component.

When a branch line or a support pole is laid on the pole, the model creation unit of the facility state analysis apparatus according to the present invention represents the branch line or the support pole by a spring element with a spring that connects the pole, an attachment point of the pole on which the branch line or the support pole is laid, and a fixed point in the ground, and the calculation unit analyzes a state change of the pole by the finite element method also including the spring element.

When an accessory is attached to the pole, the model creation unit of the facility state analysis apparatus according to the present invention discretizes the accessory to represent the accessory by an accessory element, and the calculation unit analyzes a state change of the pole by the finite element method also including the accessory element.

Further, a program according to the present invention is a program for causing a computer to execute discretizing a portion of a pole that is not in a ground, the pole having a truncated cone shape whose part is in the ground to, represent the pole by elements, and representing a portion in the ground of the pole by ground elements of a horizontal spring in a direction horizontal to the ground and a vertical spring vertical to the ground, and providing, to the elements and the ground elements, a fluctuation due to a disturbance in force applied to the pole and tension applied from a cable laid on the pole, and analyzing a state change of the pole by a finite element method. The facility state analysis apparatus according to the present invention can also be implemented by a computer and a program. The program can also be recorded in a recording medium, and can also be provided through a network.

Note that each of the inventions described above can be combined with each other to the extent possible.

### Effects of the Invention

The present invention can provide a facility state analysis apparatus, a facility state analysis method, and a program capable of extracting a pole having a high risk without an inspector visiting a site.

### BRIEF DESCRIPTION OF DRAWINGS

FIG. 1 is a diagram illustrating a situation where an unbalanced load is generated and a technique for improving the situation.

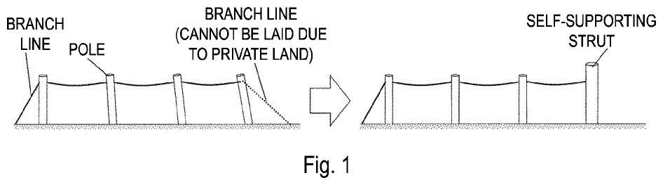

FIG. 2 is a diagram illustrating a facility state analysis apparatus according to the present invention.

FIG. 3 is a flowchart illustrating a facility state analysis method according to the present invention.

FIG. 4 is a diagram illustrating a facility system model to be analyzed.

FIG. 5 is a diagram illustrating a technique for calculating tension from a wind direction and a wind speed in the facility state analysis apparatus according to the present invention.

FIG. 6 is a diagram illustrating a material characteristic of a concrete pole.

FIG. 7 is a diagram illustrating an analysis model (element) of a pole.

FIG. 8 is a diagram illustrating ground elements.

FIG. 9 is a diagram illustrating elements of a branch line or a support pole.

FIG. 10 is a diagram illustrating a result of analyzing the facility system model by the facility state analysis apparatus according to the present invention.

FIG. 11 is a diagram illustrating the facility state analysis apparatus according to the present invention.

### DESCRIPTION OF EMBODIMENTS

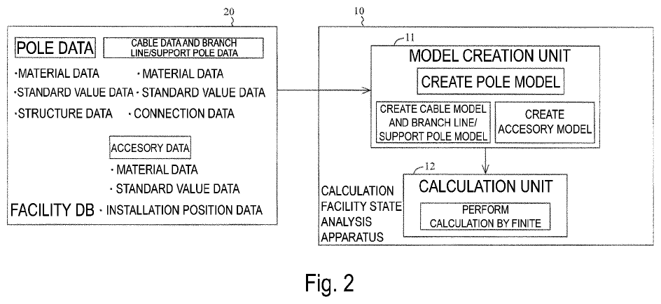

FIG. 2 is a diagram illustrating a facility state analysis apparatus 10 according to the present embodiment. The facility state analysis apparatus 10 includes a model creation unit 11 and a calculation unit 12. Here, the model creation unit 11 discretizes a portion of a pole that is not in a ground, the pole having a truncated cone shape whose part is in the ground to represent the pole by elements, and represents a portion in the ground of the pole by ground elements of a horizontal spring in a direction horizontal to the ground and a vertical spring vertical to the ground. The calculation unit 12 provides, to the element and the ground elements, a fluctuation due to a disturbance in force applied to the pole and tension applied from a cable laid on the pole, and analyzes a state change of the pole by a finite element method.

A facility database 20 stores structure data of a manufacturer maker as pole data for each material of a pole and each standard value. Here, the material of a pole represents concrete, steel tube, or the like, and the standard value refers to a height, a thickness, a design load being a load that the pole can withstand, and the like. Since manufacturer makers uniquely have a bar arrangement, a steel thickness, and the like that conform to the standard value, structure data for each of the manufacturer makers is required for an analysis.

Further, the facility database 20 similarly stores material data of a cable and a branch line/support pole laid on a pole, standard value data, and connection data of which position of the pole the cable and the branch line/support pole are laid. Furthermore, the facility database 20 similarly stores material data, standard value data, and installation position data in an accessory such as a transformer of power.

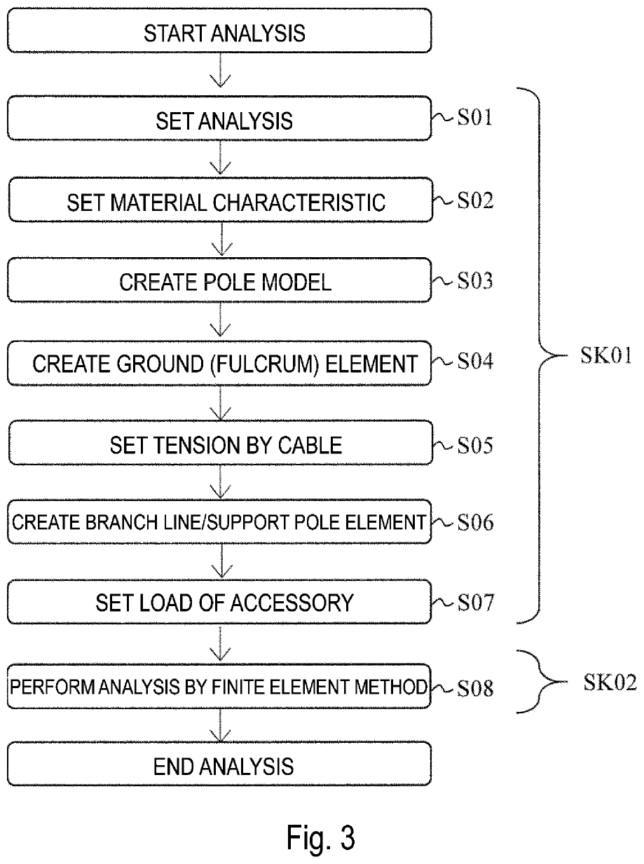

The facility state analysis apparatus 10 creates various models, based on the data stored in the facility database 20, and performs an analysis by the finite element method. FIG. 3 is a flowchart illustrating the analysis method. The analysis method performs a pole model creation step SK01 and a calculation step SK02. Here, the pole model creation step SK01 discretizes a portion of a pole that is not in a ground, the pole having a truncated cone shape whose part is in the ground to represent the pole by elements, and represents a portion in the ground of the pole by ground elements of a horizontal spring in a direction horizontal to the ground and a vertical spring vertical to the ground. The calculation step SK02 provides, to the element and the ground elements, a fluctuation due to a disturbance in force applied to the pole and tension applied from a cable laid on the pole, and analyzes a state change of the pole by the finite element method.

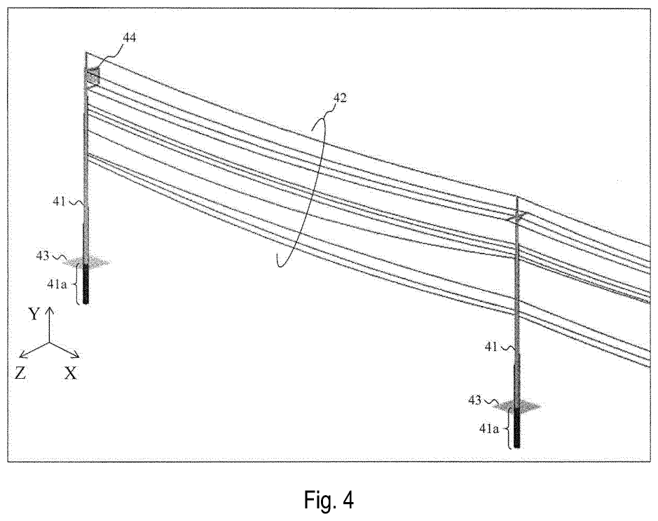

The analysis method will be described with a facility model in FIG. 4. The analysis method is a method of modeling a pole 41, a cable 42 and a branch line and a support pole (not illustrated) laid on the pole 41, and an accessory 44, and estimating effective tension and calculating residual strength in a facility group. The pole 41, the cable 42 and the branch line and the support pole (not illustrated) laid on the pole 41, and the accessory 44 are collectively referred to as a “facility system”.

Step S01

In this step, an analysis is set.
First, as illustrated in FIG. 4, coordinate information (x, y, z coordinates) of three axes is provided to a facility system to be analyzed. Next, a direction and a speed of wind caught by the pole 41 and the cable 42, and a temperature are set. Here, the presence or absence of wind, and a direction and a speed of the wind generate stress on the pole 41 itself, and also affect tension provided on the pole by the cable 42. A load generated on the cable 42 by the wind is represented as follows.

[Math. 1]

P_{c}=K·Σd·S (1)

Here, P_{c} is a load generated on the cable, K is a coefficient according to a wind load type, Σd is a sum of an outer diameter of the cable, and S is an average distance between poles.

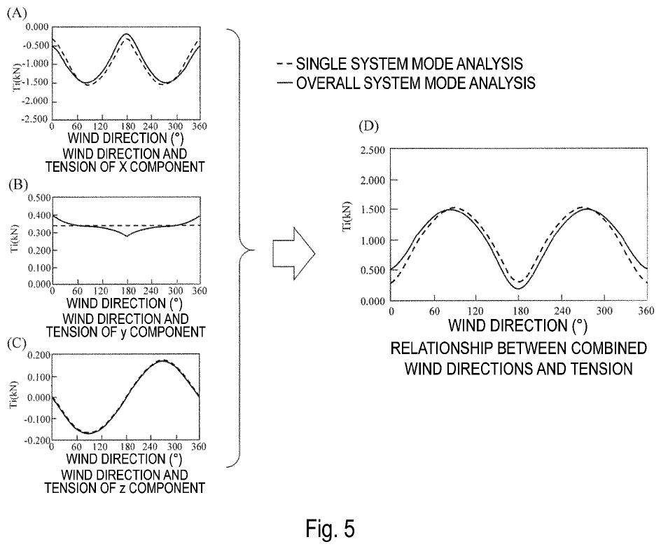

A direction of wind blowing to the pole 41 and the cable 42 is converted into vectors in three-axis directions, and a load due to wind pressure is converted. As illustrated in FIG. 4, the facility system has x, y, z coordinates, but it needs to be considered that the wind blows from directions (α, β, γ coordinates) regardless of their coordinate planes. Thus, the calculation unit 12 divides the three planes of the x, y, and z planes, calculates tension (Tix, Tiy, Tiz) from a wind direction and a wind speed, and then combines the tension and analyzes a relationship among the wind direction, the wind speed, and tension Ti. For example, as illustrated in FIGS. 5(A), 5(B), and 5(C), a relationship between a wind direction and tension when wind blows from a single direction in each of the x-axis, the y-axis, and the z-axis is calculated in advance, the relationships are combined, and a relationship between the wind direction and the tension in a facility system illustrated in FIG. 5(D) is acquired.

A temperature is also considered in addition to the wind. As a temperature decreases, the cable 42 shrinks and thus tension increases. The tension is also calculated in consideration of an influence of the temperature. Here, a relationship between the temperature and the tension when the wind speed changes is as follows.

$$\begin{matrix}[ Math . 2 ] & \\ {d}_{1}^{3} + \{ \frac{3}{8} {s}^{2} ( \frac{{T}_{0}}{EA} - α ( {θ}_{1} - {θ}_{0} ) ) - {d}_{0}^{2} \} {d}_{1} = \frac{3 {W}_{1} {S}^{4}}{64 E A} & ( 2 )\end{matrix}$$

Here, d₀ is a sag with no wind, d₁ is a sag with wind, S is a distance between poles, T₀ is tension with no wind, E is a Young's modulus of the cable, A is a cross-sectional area of the cable, a is a coefficient of thermal expansion of the cable, θ₀ is a temperature with no wind, θ₁ is a temperature with wind, and W₁ is a combined load of a cable weight of a unit length and a wind load.

Step S02

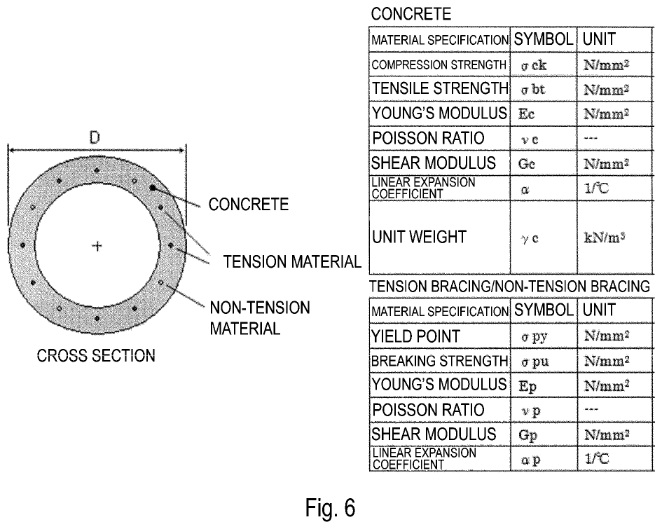

In this step, the model creation unit 11 sets a material characteristic.
The model creation unit 11 acquires pole data from the facility database 20. As a material of the pole, there are concrete and steel that each have a different material characteristic. As illustrated in FIG. 6, a concrete pole (CP) has a structure with a tension bracing provided with stress therein and a non-tension bracing provided with no stress, and thus a material characteristic of the tension bracing and the non-tension bracing is required in addition to a material characteristic such as compression/tensile strength of concrete and a Young's modulus. Further, since a stainless steel pole (SP) is constituted only by steel, a material characteristic such as yield/tensile strength peculiar to steel and a Young's modulus is required.

Step S03

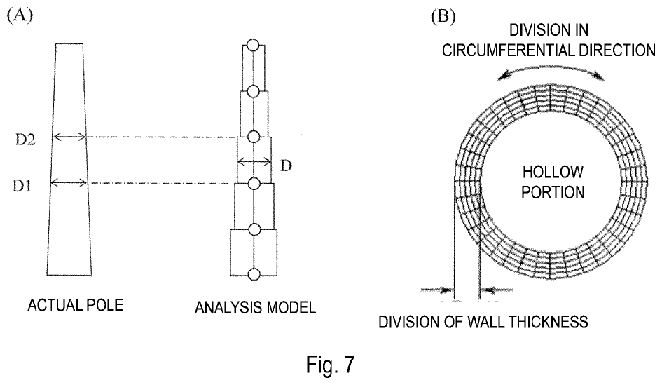

In this step, the model creation unit 11 creates a pole model.
Since an actual pole has various shapes such as a cylindrical shape and a tapered shape, the actual pole is divided in a longitudinal direction as illustrated in FIG. 7(A), and diameters (D1 and D2) are set for each portion. Then, the divided portion is considered as a cylinder having a diameter D, and an analysis model of the pole is created. A finer analysis can be achieved with more divisions in a vertical direction. In order to further model the cross-section of the cylinder, a circumferential direction and a wall thickness are divided into mesh shapes (discretization). The divided region described above is referred to as an “element”. In an analysis described later, calculation by the finite element method is performed in consideration of a material characteristic, an external load, and the like for all the elements.

Step S04

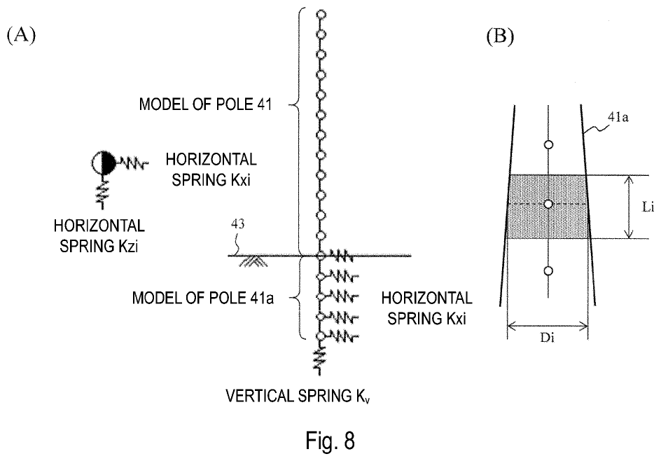

In this step, the model creation unit 11 creates ground elements.
A pole 41a in the ground is divided in the longitudinal direction as illustrated in FIG. 8(B), and a diameter Di and a division interval Li are set for each portion. Then, as illustrated in FIG. 8(A), ground elements are acquired on the assumption that a horizontal spring (Kₓᵢ, K_{zi}) in the horizontal direction with respect to a ground 43 and a vertical spring (Kᵥ) are provided in each portion. In the analysis described later, the ground elements are analyzed in the following relational expression.

[Math. 3]

Kₓᵢ=K_{zi}=K·Aₕ

Kᵥ=K·Aᵥ

Aₕ=Dᵢ·Lᵢ (3)

Here, Kₓᵢ and K_{zi} are a spring constant of the horizontal spring in the horizontal direction (x and z directions) with respect to the ground, Kᵥ is a spring constant of the vertical spring in the vertical direction (y direction) with respect to the ground, K is a ground reaction coefficient, Aₕ is a horizontal projection area (hatched portion in FIG. 8(B)) of a pole member, and Aᵥ is a cross-sectional area of a pole bottom surface.

Step S05

In this step, the model creation unit 11 sets tension by the cable 42.
The setting of the tension by the cable can be represented by the following equation.

$$\begin{matrix}[ Math . 4 ] & \\ T = \frac{{WS}^{2}}{8 d} & ( 4 )\end{matrix}$$

Here, T is cable tension, W is a cable weight per unit length, S is a distance between poles, and d is a cable sag.
In other words, tension T₀ with no wind, and tension T₁ with wind and when a temperature fluctuates is as in [Math. 5].

$${T}_{0} = \frac{{WS}^{2}}{8 {d}_{0}} \\ {T}_{1} = \frac{{W}_{1} {S}^{2}}{8 {d}_{1}} \qquad ( 5 )$$

By transforming them for d₀ and d₁ and substituting them into Math 4, a relational expression of the tension T₁ with wind and when a temperature fluctuates can be represented by the following equation.

$$\begin{matrix}[ Math . 6 ] & \\ {T}_{1}^{3} + EA \{ α ( {θ}_{1} - {θ}_{0} ) + \frac{1}{24} {( \frac{WS}{{T}_{0}} )}^{2} - \frac{{T}_{0}}{EA} \} {T}_{1}^{2} = \frac{1}{24} {EA ( {W}_{1} \cdot S )}^{2} & ( 6 )\end{matrix}$$

In step S08 described later, the calculation unit 12 performs an analysis by using the relational expression.

Step S06

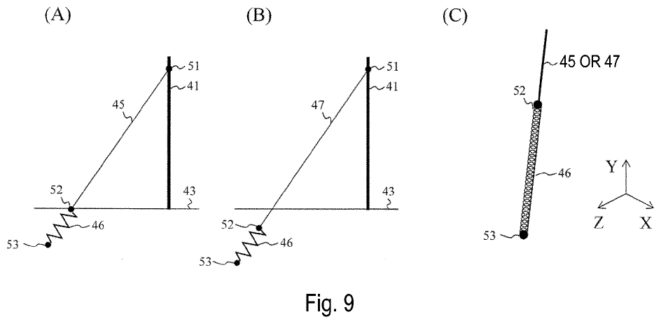

In this step, the model creation unit 11 creates elements of a branch line or a support pole laid on the pole 41. Note that, when a branch line or a support pole is not provided on the pole 41, this step is not required.
It is assumed that the branch line or the support pole has a spring in the ground in the longitudinal direction as in FIG. 9, and a model of a spring element 46 is formed. FIG. 9(A) is a model of the branch line, FIG. 9(B) is a model of the support pole, and FIG. 9(C) is an enlarged view of the spring portion. The model is constituted by a fixed point 53 without variation of a load, a base 52 at which the spring element 46 occurs, and an attachment point 51 to the pole 41.

Step S07

In this step, the model creation unit 11 sets a load and a laying position of the accessory 44 laid on the pole 41. The accessory 44 is, for example, a transformer of power and the like. Note that, when an accessory is not attached to the pole 41, this step is not required.

Note that step S02 to step S07 are the model creation step SK01 described above.

Step S08

In this step, the calculation unit 12 provides, to the element created in step S03 and the ground elements created in step S04, the tension T₀ with no wind and the tension T₁ according to a change in wind and temperature that are set in step S05, and analyzes a state change of the pole 41 by the finite element method. Since a branch line or a support pole may be laid, and an accessory may be attached, depending on a pole, the spring element created in step S06 and a load of the accessory 44 are also considered in this case. Step S08 is the calculation step SK02 described above.

### Effects of the Invention

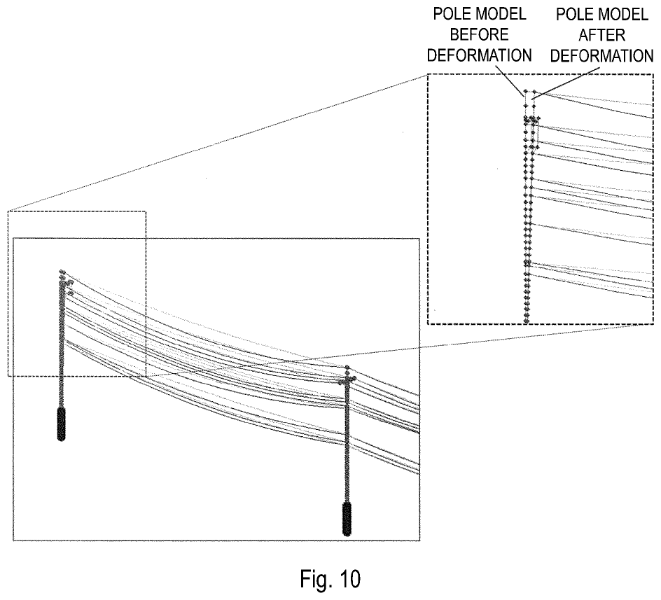

As described above, creation of a model of a pole, creation of elements, and various types of setting are performed, and a load and effective tension acting on a facility group can be estimated by using the finite element method. FIG. 10 is a diagram in which a pole model with no wind and a pole model with any wind direction and wind speed are compared (temperature is the same). How the pole becomes deformed by a fluctuation in tension from a cable is determined from FIG. 10.

Further, in a pole, there are an acceptable load referred to as a design load and tension. In the facility state analysis method, a load and tension applied to each pole can be determined, and thus how much more a current state can withstand a load and tension, which is so-called residual strength, can be calculated.

In the facility state analysis method, a pole group having a high risk (great unbalanced load and small residual strength) can be extracted without an inspector with a high level of skill inspecting all of the poles. Thus, prioritization when an inspection is performed can be achieved, and, in addition, the amount of time for an operator to actually visit a facility can also be reduced.

Furthermore, by converting residual strength into a load and tension due to a wind speed, a wind speed having a risk of causing a collapse can be calculated. Furthermore, a design change such as a moderate adjustment to a sag of a cable group present between poles and a reduction in distance between poles with reference to an analysis result is also facilitated. Further, an optional analysis can also be performed such that a pole having an optimal design load moves up in ranking in consideration of residual strength in a facility system instead of using a self-supporting strut of a great cost or the like.

Thus, by using the facility state analysis method, an unbalanced load can be eliminated by moving up a pole having an optimal design load in ranking in consideration of residual strength in a facility system, and thus a usage period of a pole and the like can be greatly increased and a facility at a low cost can be used without sacrificing safety. In other words, by using the facility state analysis method, an overall cost can be greatly reduced.

### EXAMPLE

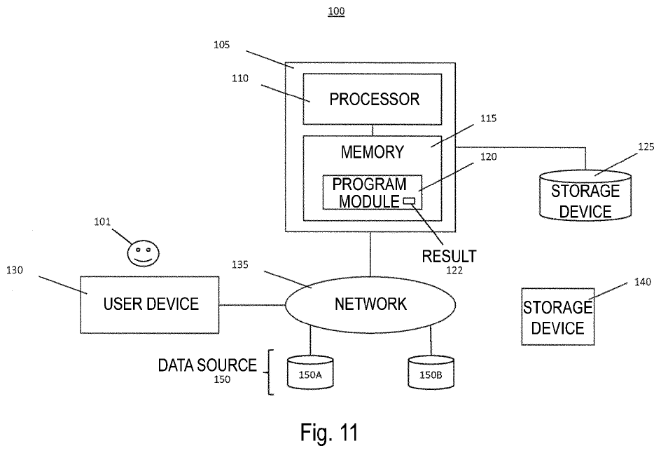

FIG. 11 illustrates a block diagram of a system 100. The system 100 includes a computer 105 connected to a network 135.

The network 135 is a data communication network. The network 135 may be a private network or a public network, and can include any or all of (a) a personal area network covering a certain room, for example, (b) a local area network covering a certain building, for example, (c) a campus area network covering a certain campus, for example, (d) a metropolitan area network covering a certain city, for example, (e) a wide area network covering an area connected across a boundary of a city, a locality, or a nation, for example, and (f) the Internet. The communication is performed by an electronic signal and an optical signal via the network 135.

The computer 105 includes a processor 110 and a memory 115 connected to the processor 110. The computer 105 is represented as a stand-alone device in the present specification, but the present invention is not limited thereto, and the computer 105 may be rather connected to another device (not illustrated) in a distributed processing system.

The processor 110 is an electronic device constituted by a logic circuit that responds to and executes a command.

The memory 115 is a storage medium readable by a tangible computer in which a computer program is encoded. In this regard, the memory 115 stores data and a command, i.e., a program code, readable and executable by the processor 110 in order to control an operation of the processor 110. The memory 115 can be implemented by a random access memory (RAM), a hard drive, a read-only memory (ROM), or a combination thereof. One of the components of the memory 115 is a program module 120.

The program module 120 includes a command for controlling the processor 110 so as to execute the processes described in the present specification. In the present specification, it is described that an operation is performed by the computer 105, a method or a process, or a subordinate process, but the operation is actually performed by the processor 110.

A term “module” is used in the present specification to refer to a functional operation that may be embodied as any integrated configuration formed of a stand-alone component or a plurality of subordinate components. Therefore, the program module 120 may be implemented as a single module or a plurality of modules that operate in cooperation with each other. Furthermore, in the present specification, it is described that the program module 120 is installed in the memory 115 and thus implemented by software, but the program module 120 may be implemented by any of hardware (e.g., electronic circuit), firmware, software, and a combination thereof.

It is illustrated that the program module 120 is already loaded into the memory 115, but the program module 120 may be configured to be located on a storage device 140 so as to be loaded later into the memory 115. The storage device 140 is a storage medium readable by a tangible computer storing the program module 120. Examples of the storage device 140 include a compact disc, a magnetic tape, a read-only memory, an optical storage medium, a memory unit constituted by a hard drive or a plurality of hard drives, and a universal serial bus (USB) flash drive. Alternatively, the storage device 140 may be a random access memory, or an electronic storage device of another type located in a remote storage system (not illustrated) and connected to the computer 105 via the network 135.

The system 100 further includes a data source 150A and a data source 150B collectively referred to as a data source 150 in the present specification and communicatively connected to the network 135. In practice, the data source 150 can include any number of data sources, i.e., one or more data sources. The data source 150 can include non-systematized data and include social media.

The system 100 further includes a user device 130 operated by a user 101 and connected to the computer 105 via the network 135. Examples of the user device 130 include an input device, such as a keyboard or a speech recognition subsystem for allowing the user 101 to transmit selection of information and a command to the processor 110. The user device 130 further includes an output device, such as a display device, or a printer or a speech synthesizer. A cursor control unit, such as a mouse, a trackball, or a touch sensitive screen, allows the user 101 to operate a cursor on a display device in order to transmit further selection of information and a command to the processor 110.

The processor 110 outputs a result 122 of execution of the program module 120 to the user device 130. Alternatively, the processor 110 can provide output to a storage device 125, such as a database or a memory, for example, or can provide output to a remote device (not illustrated) via the network 135.

For example, a program that executes the flowchart in FIG. 3 may be the program module 120. Further, the facility database illustrated in FIG. 2 can be the storage device 125 or 140. The system 100 can operate as a the facility state analysis apparatus 10.

A term “including . . . ” or “provided with . . . ” specifies the presence of a feature, an integer, a step, or a component described therein, but it should be understood that the presence of one or more other features, integers, steps, or components, or a group thereof is not excluded. Terms “a” and “an” are indefinite articles, and do not thus exclude the embodiments having a plurality thereof.

### Additional Description

The present invention relates to a technique for estimating a state of a facility mainly located outside, such as a pole such as a utility pole and a signal post, and a cable and a branch line that are laid on the pole, such as a power line and a telephone line, by calculating tension and moment applied to a facility group from a material characteristic and the like of the facility.

The present invention is a technique and a program for analyzing a load and tension on a single pole or a pole group from a material, a standard value, and the like by using the finite element method, and analyzing a facility state thereof.

The present invention is a technique and a program for analyzing a load and tension on a facility group from a material, a standard value, and the like by using the finite element method, and analyzing residual strength of the facility group. The present invention is a technique and a program for calculating, from residual strength in the facility group created above, a wind speed that the facility group can withstand, and estimating a risk of a collapse and the like.

The present invention is a technique and a program for analyzing a load and tension on a facility group from a material, a standard value, and the like by using the finite element method, and analyzing a pole and a cable with a great unbalanced load in the facility group.

The present invention is a technique and a program for optimizing cable tension and estimating an arrangement of a branch line or a support pole in order to eliminate unbalance in the pole and the cable created above with a great unbalanced load.

### REFERENCE SIGNS LIST

10: Facility state analysis apparatus
11: Model creation unit
12: Calculation unit
20: Facility database
100: System
101: User
105: Computer
110: Processor
115: Memory
120: Program module
122: Result
125: Storage device
130: User device
135: Network
140: Storage device
150: Data source

1. A facility state analysis apparatus, comprising:
a model creation unit configured to discretize a portion of a pole that is not in a ground, the pole having a truncated cone shape whose part is in the ground to represent the pole by elements, and represent a portion in the ground of the pole by ground elements of a horizontal spring in a direction horizontal to the ground and a vertical spring vertical to the ground; and
a calculation unit configured to provide, to the elements and the ground elements, a fluctuation due to a disturbance in force applied to the pole and tension applied from a cable laid on the pole, and analyze a state change of the pole by a finite element method.

2. The facility state analysis apparatus according to claim 1, wherein
the disturbance is wind, and
the calculation unit represents a space by three axes, calculates the tension from a wind direction and a wind speed for each component, and combines the tension of each component.

3. The facility state analysis apparatus according to claim 1 or 2, wherein,
when a branch line or a support pole is laid on the pole,
the model creation unit represents the branch line or the support pole by a spring element with a spring that connects the pole, an attachment point of the pole on which the branch line or the support pole is laid, and a fixed point in the ground, and
the calculation unit analyzes a state change of the pole by the finite element method also including the spring element.

4. The facility state analysis apparatus according to any of claims 1 to 3, wherein,
when an accessory is attached to the pole,
the model creation unit discretizes the accessory to represent the accessory by an accessory element, and
the calculation unit analyzes a state change of the pole by the finite element method also including the accessory element.

5. A facility state analysis method, comprising:
discretizing a portion of a pole that is not in a ground, the pole having a truncated cone shape whose part is in the ground to represent the pole by elements, and representing a portion in the ground of the pole by ground elements of a horizontal spring in a direction horizontal to the ground and a vertical spring vertical to the ground; and
providing, to the elements and the ground elements, a fluctuation due to a disturbance in force applied to the pole and tension applied from a cable laid on the pole, and analyzing a state change of the pole by a finite element method.

6. A program for causing a computer to execute:
discretizing a portion of a pole that is not in a ground, the pole having a truncated cone shape whose part is in the ground to represent the pole by elements, and representing a portion in the ground of the pole by ground elements of a horizontal spring in a direction horizontal to the ground and a vertical spring vertical to the ground; and
providing, to the elements and the ground elements, a fluctuation due to a disturbance in force applied to the pole and tension applied from a cable laid on the pole, and analyzing a state change of the pole by a finite element method.
